(19) United States
(12) Patent Application Publication
(10) Pub. No.: US 2007/0189464 A1
(43) Pub. Date: Aug. 16, 2007

(54) Method for distributing hardware and software resources for high bit rate link control

(76) Inventors: Jean Schmitt, Rouvres (FR); Dominique Le Foll, Ivybridge (GB)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 11/550,032

(22) Filed: Oct. 17, 2006

(30) Foreign Application Priority Data
Oct. 18, 2005 (FR) 05 53158

(51) Int. Cl. H04M 1/24; H04M 3/08; H04M 3/22

(52) U.S. Cl. 379/1.01

(57) ABSTRACT

Method for distributing hardware and software resources for testing links between a plurality of subscriber devices and a telecommunications operator in a telecommunications network, comprising:
a central control site (2),
at least one intermediate connection site (4), connected on the one hand to the central site (2) by a first transmission line (3), and on the other hand to the subscriber devices (12) by a second transmission line (13). This method is characterised by the following steps:
defining the tests to be performed on the first line (3) and the tests to be performed on the second line (13),
distributing said hardware and software resources between said central site (2) and said intermediate connection site (4) depending on the tests likely to be performed on the first transmission line (3) and on the second transmission line (13) respectively.

### TECHNICAL FIELD

The invention relates to the field of telecommunications and more specifically concerns a method for distributing hardware and software resources for testing links between a plurality of subscriber devices and a telecommunications operator in a telecommunications network.

The invention is applied in a network comprising a central control site located at the operator and at least one intermediate connection site, connected on the one hand to the central site by a first transmission line and on the other hand to the subscriber devices by a second transmission line.

The invention also relates to an architecture for distribution of hardware and software resources for testing links between a plurality of subscriber devices and a telecommunications operator.

This architecture comprises a central control site including a central control head and at least one intermediate connection site, connected on the one hand to the central site by a first wire or optical fibre transmission line, and on the other hand to the subscriber devices via the copper pair of the access network.

### PRIOR ART

The xDSL (digital subscriber line) techniques are increasingly used to provide high bit rate data transmissions, generally on the order of a plurality of megabits per second, over wires traditionally used for analog telephony. It is therefore imperative for the telecommunications operators and the high bit rate service providers to have reliable techniques in order to ensure effective testing of the transmission lines between the operator and the subscriber, so as to comply with the quality of service agreed upon.

To avoid requiring the movement of technicians in order to perform these tests, and thus to reduce the maintenance costs and the inconveniences caused to the subscribers, the operators use measurement heads installed at their own site. These measurement heads process the data provided by probes distributed at various points on the line tested.

FIG. 1 diagrammatically shows a network architecture in which the line tests according to the prior art are implemented.

As shown in this FIG. 1, the network architecture comprises a central site 2 connected by optical fibre 3 to an intermediate connection site 4 comprising a first remote terminal 5 and a second remote terminal 6.

The first terminal 5 comprises a DSLAM multiplexer 10 connected directly to subscriber premises 12 via the access network 13.

The second terminal 6 is connected by a wire telephone line and by a Hertzian line to an external box 14 in which a DSLAM multiplexer 10 is provided. The external box 14 is connected to subscriber premises 12 via the access network 13.

The connection by optical fibres between the central site 2 and the remote terminals 5 and 6 does not make it possible to perform a large number of conventional end-to-end measurements, such as, for example, measurements of capacitance and resistance, normally carried out on a copper pair during line pre-qualification phases, operations or in the event of malfunction.

FIG. 2 diagrammatically shows the internal structure of the central site 2, the remote terminals 5 and 6 and the external cabin 14.

The central site 2 comprises an IP (Internet Protocol) switch 20, a conventional telephone switch 22 and a test manager 24 that performs the function of performing measurements and presenting the results to the users.

The first remote terminal 5 comprises a digital loop carrier DLC 26 and the second remote terminal 6 comprises a DSLAM multiplexer 10, a digital loop carrier DLC 26, and an access matrix 28. All subscriber premises 12 comprise at least one ATU-R modem 29 (for ADSL Unit Transmission-Remote Side) and at least one telephone terminal 31.

The methods used in the prior art to test the links between the operator and the subscriber in the architecture of FIG. 1 are based on SELT (Single End Loop Test) and DELT (Double End Loop Test) techniques.

The SELT technique can be implemented from DSLAM multiplexers or a MSAN (Multi service Access Node) multimedia multiplexer installed either in the central site 2 of the operator or in the external boxes 14 provided near the subscriber premises. This technique does not require the installation of external test equipment in the central site 2 or at a remote end of the access network, and its implementation does not require the presence of a subscriber device. Only a DSLAM or MSAM multiplexer is necessary and must support ADSL2 services. However, for the test to be possible, the DSLAM or the MSAM must be powered and on. This means that it is not possible to perform measurements when the DSLAM or the MSAM is out of order or off. In addition, in most cases, the DSLAM does not identify an unsynchronised line of a defective port, particularly when the malfunction is caused by a breakdown in the frontal analog component. Consequently, this technique is not suitable for testing a line when the DSLAM, from which it is supposed to be implemented, is defective and may be the cause of the malfunction of the line.

In addition, to obtain accurate test results, regular calibration measurements are necessary in order to compensate for variations in temperature, in particular for measurements taken from an external DSLAM multiplexer or an external box 14. These calibration measurements must be taken between the line and the ADSL2 modem. Moreover, because the SELT technique must be based on wide-band signals, it is necessary to short-circuit the voice-data buffers of the central site 2 or of the external box 14 when a filter (for example, a blocking capacity) is in series on the line. This contributes to the increase in the cost of the buffers.

Another disadvantage of the SELT technique lies in the fact that the impedance of the remote device connected to the end of the line can have a significant impact on the accuracy of the measurements. The latter depend on the type of terminal connected and the conditions of the line (telephone on or off the receiver). Indeed, a telephone on the receiver is, for the measurement device, equivalent to a high impedance (>100 KΩ), while a telephone off of the receiver corresponds to an impedance of around 900 KΩ. Without any particular precaution, the TDR (Time Domain Reflectometry), FDR (Frequency Domain Reflectometry) or S11 measurements are impaired when the line impedance is close to the impedance of the measurement output. This is the case when a remote ADSL modem is connected. In addition, the carriers transmitted by the ATU-R (ADSL Unit Transmission-Remote Side) modems significantly affect this type of measurements.

The DELT technique makes it possible to take measurements at two ends of the line to be tested, and can be implemented from a DSLAM multiplexer or from a MSAN. However, the implementation thereof requires the subscriber devices to be present at the other end of the line and synchronised with the DSLAM or the MSAN.

The objective of the invention is to overcome the disadvantages of the prior art described above.

Another objective of the invention is to reduce the line maintenance costs in the phases of pre-qualification, operations and intervention in the event of a malfunction.

Another objective is to adapt the tests to the new network architectures, while reducing the cost.

### DISCLOSURE OF THE INVENTION

These objectives are achieved by means of a method for distributing hardware and software resources for testing links between a plurality of subscriber devices and a telecommunications operator in a telecommunications network, comprising:
a central control site,
at least one intermediate connection site, connected on the one hand to the central site by a first transmission line, and on the other hand to the subscriber devices by a second transmission line.

The method according to the invention comprises the following steps:
defining the tests to be performed on the first line and the tests to be performed on the second line,
distributing said hardware and software resources between said central site and said intermediate connection site depending on the tests capable of being performed respectively on the first transmission line and on the second transmission line.

This method is preferably applied when said first and second transmission lines comprise optical fibres and/or wire cables.

In a first embodiment, the method comprises the following steps:
connecting the central site and the intermediate site by a first calibrated copper pair,
determining the total attenuation from end-to-end between the central site and the subscriber devices,
deducing, from said total attenuation, the attenuation on said second transmission line,
determining, from the attenuation on said second line, the maximum bit rate capable of transiting via this second transmission line.

In a second embodiment, the method comprises the following steps:
performing a first group of measurements by means of at least one remote control head provided in the intermediate site,
transmitting the results of said measurements to a central control head provided in the central site,
taking measurements on the wire connections on the second transmission line by means of an access matrix provided in said intermediate site.

The method according to the invention is implemented in a network architecture comprising:
a central control site in which a central control head is provided,
at least one intermediate connection site connected on the one hand to the central site by a first transmission line, and on the other hand to the subscriber devices by a second transmission line.

In this architecture, the hardware and software test resources are distributed between said central site and said intermediate site depending on the type of test likely to be performed respectively on the first transmission line and on the second transmission line.

### BRIEF DESCRIPTION OF THE DRAWINGS

FIG. 1, described above, diagrammatically shows a network architecture of the prior art;

FIG. 2 diagrammatically shows a detailed representation of FIG. 1;

FIG. 3 diagrammatically shows a distribution of test resources according to a first embodiment of the invention;

FIG. 4 diagrammatically shows a distribution of test resources according to a second embodiment of the invention;

FIG. 5 diagrammatically shows the data stream in the network architecture shown in FIG. 4;

FIG. 6 diagrammatically shows a first alternative for distribution of line test resources in the architecture of FIG. 4;

FIG. 7 diagrammatically shows a second alternative for distribution of the line test resources in the architecture of FIG. 4.

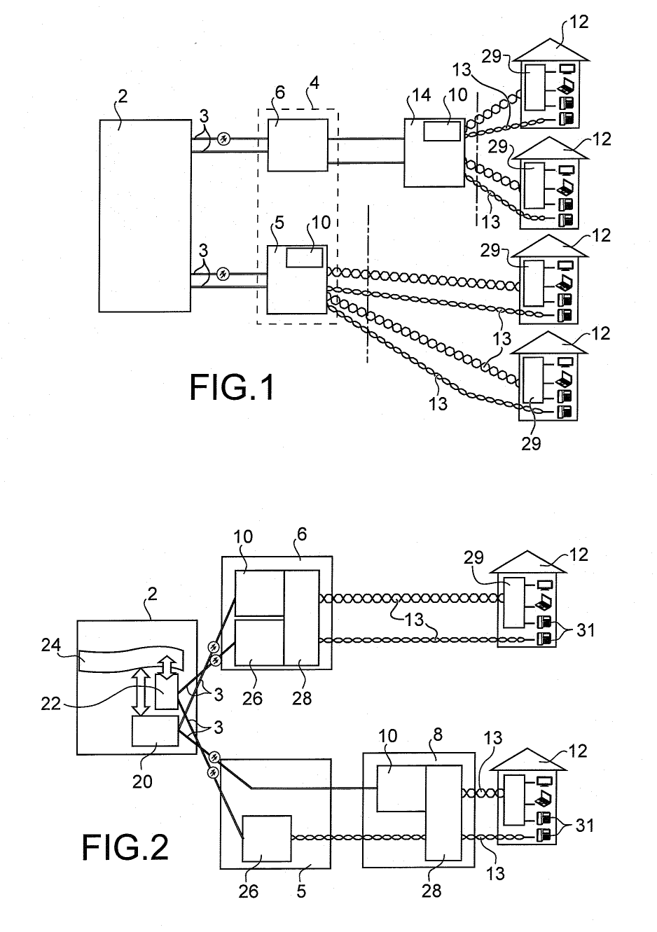

### DETAILED DESCRIPTION OF SPECIFIC EMBODIMENTS

In the following description, identical references will be used to designate the elements serving identical functions that are common to the figures showing the prior art and to the figures illustrating the invention.

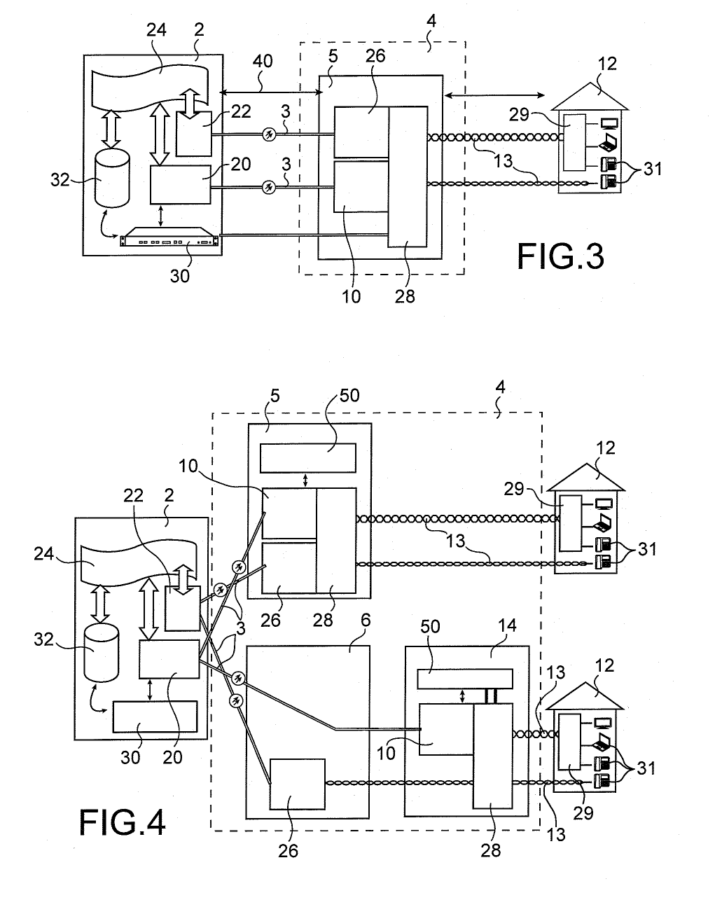

FIG. 3 shows a network architecture comprising a central site 2, an intermediate connection site 4 and subscriber premises 12. The central site 2 is connected by optical fibres 3 to the intermediate connection site 4. The latter is connected to the subscriber premises 12 via the access network 13 over which the conventional telephone and high bit rate xDSL services travel.

The central site 2 comprises an IP switch 20, a telephone switch 22, a test manager 24, a central control head 30 and a test database 32.

The intermediate connection site 4 comprises a remote terminal 5 including a DSLAM multiplexer 10, a digital loop carrier DLC 26 and an access matrix 28.

The subscriber premises 14 comprise an ATU-R (ADSL Unit Transmission-Remote Side) modem 29 and one or more telephone terminals 31.

The central site 2 is also connected to the remote terminal 5 by a wire link, such as, for example, a calibrated copper pair 40 intended to extend the wire connection 13 between the central site 2 and the subscriber premises 12 in order to allow the central control head 30 to measure the total attenuation from end-to-end and to deduce, from said total attenuation, the attenuation on the copper pair of the access network 13. This enables the control head 30 to determine the maximum bit rate capable of transiting via the copper pair 13.

The attenuation on this second transmission line 13 is calculated by subtracting the attenuation on the calibrated copper pair 40 from the total attenuation measured. The maximum bit rate capable of transiting via the second transmission line is then calculated from the attenuation on said second transmission line.

FIG. 4 shows a second test resource distribution mode in a network architecture in which the intermediate connection site 4 also comprises a second remote terminal 6 including a digital loop carrier DLC 26 connected to an external box 14. The latter comprises a remote DSLAM 10, a remote control head intended to perform a second group of line test functions, and an access matrix 28 for performing wire connection tests on the access network 13.

In the architecture described in FIG. 4, the central control head 30 comprises resources for performing the following functions:
communication with a test manager 24, which performs the function of checking measurements and presenting the results to the users,
management of the interface with the remote control head 50,
processing of the uncorrected results of the measurements taken by the remote control heads 50,
processing of the reflectometric measurements taken by the remote control head 50 so as to obtain the attenuation, the length and possibly the topology of the line 13,
detection of ATU-R modems 29,
prediction of bit rate from attenuations measured on the cables of the second link 13 and from the broadband noise measured at the level of the remote control head 50,
verification of the functioning of the remote modems (ATU-R) 29 by xDSL synchronisation and activation of the upper layers such as ATM, PPP and IPVideo layers,
detection of line branching from frequency domain reflectometry (FDR) processing operations and from remote capacitance measurements,
narrow band verifications of possible resistive and/or capacitive defects in alternating and direct current,
detection of inductive loads,
presentation and remote processing of the measurement results.

The remote control head 50 provided in the first remote terminal 5 comprises resources for performing the following functions:
communication with the central control head 30,
emulation of ATU-R modems 29 in order to test the ports of the DSLAM multiplexer 10 and the availability of multimedia services (voice, data, video),
monitoring and measurement of broadband and narrow band noise,
detection of ATU-R modems 29,
measurement of capacitance and resistance,
testing of AC and DC voltages,
verification of the telephone service provided via the line 13,
verification of line identifiers,
detection of inductive loads or branch lines.

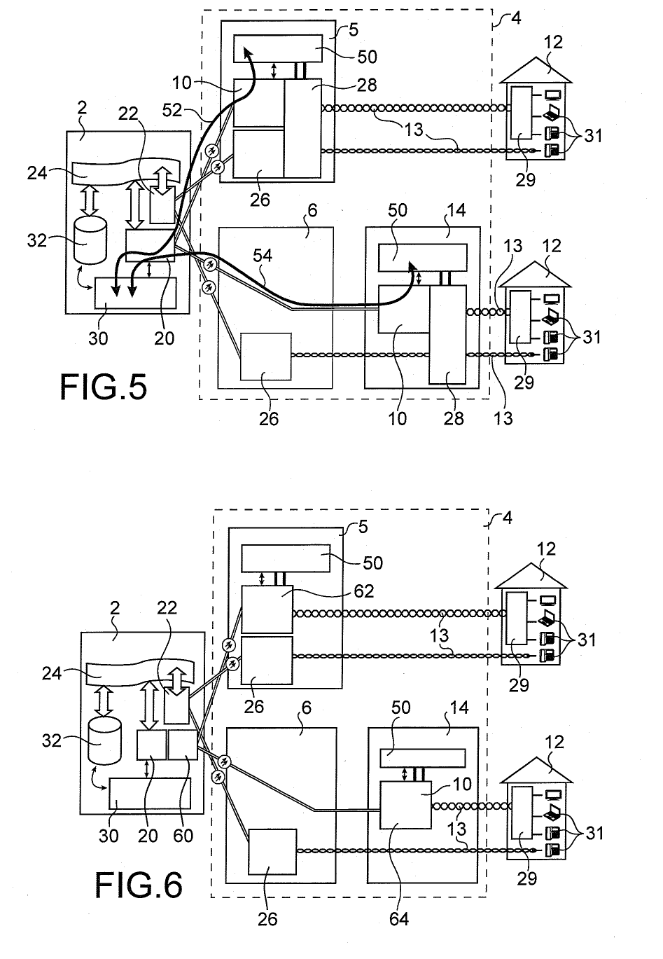

All of the measurement data obtained by the remote control heads 50 is transmitted in IP packets to the central control head 30, as diagrammatically shown in FIG. 5 by arrows 52 and 54.

FIG. 6 shows a third mode of distribution of test resources in a network architecture in which the central site 2 comprises a first DSLAM DSP (digital signal processing) processing and multiplexing module 60 intended for the processing of a first group of DSLAM functions (DSP). In this architecture, the intermediate connection site 4 comprises a first remote terminal 5 directly connected to a first group of subscriber devices 12 via the access network 13 and including a second module for AFE (Analog Front End) DSLAM processing and multiplexing 62 intended for the processing of a second group of functions, a digital loop carrier DLC 26, and a remote control head intended to perform a portion of the line tests.

In this architecture, the intermediate connection site 4 also comprises a second remote terminal 6 connected to a second group of subscriber devices 12 via an external box 14 including a digital carrier 26, a remote control head 50 intended to perform a portion of the line tests, and a third module for AFE DSLAM multiplexing 64 intended for the processing of a third group of functions.

In this architecture, the central control head 30 provided in the central site 2 performs the following functions:
communication with a test manager 24 that performs the function of checking the measurements and presenting the results to the users,
management of the interface with the remote control head 50,
processing of the uncorrected results of the measurements taken by the remote control heads 50;
processing of the reflectometric measurements taken by the remote control heads 50 in order to obtain the attenuation, the length and possibly the topology of the lines 13,
detection of ATU-R modems 29,
prediction of bit rate attenuations measured on the cables of the second link 13 and from the broadband noise measured at the level of the remote control heads 50,
verification of the proper functioning of the remote modem (ATU-R) 29 by xDSL synchronisation and activation of the upper layers such as the ATM, PPP and IPVideo layers,
detection of line branching from frequency domain reflectometry (FDR) processing operations and from remote capacitance measurements,
narrow band verifications of possible resistive and/or capacitive defects and measurement of alternating and direct voltages or currents,
detection of inductive loads,
presentation and remote processing of the measurement results.

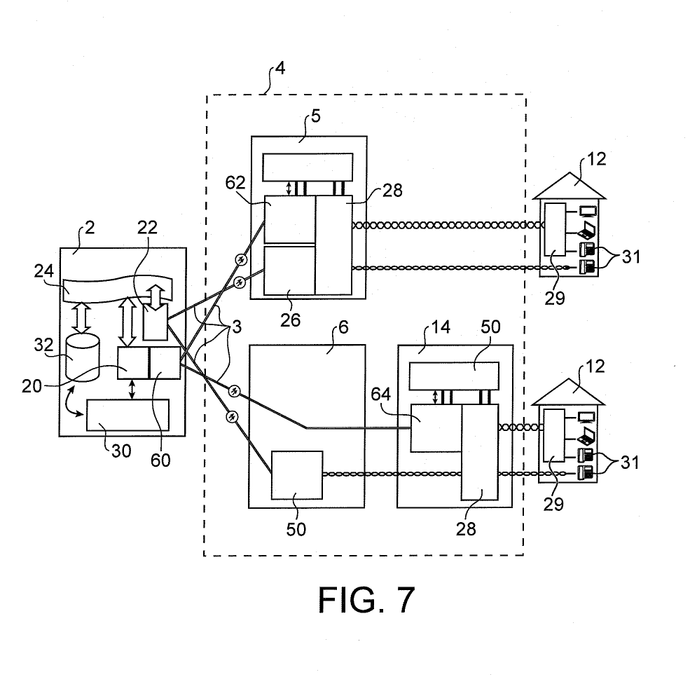

FIG. 7 shows a fourth embodiment of the network architecture in which the first remote terminal 5 and the external box 14 also comprise an access matrix 28 for enabling the central control head 30 to perform the following functions:
measurement of capacitance and resistance,
testing of AC and DC voltages,
verification of telephone lines,
verification of line identifiers,
detection of inductive loads.

1. Method for distributing hardware and software resources for testing links between a plurality of subscriber devices and a telecommunications operator in a telecommunications network, comprising:
a central control site (2),
at least one intermediate connection site (4), connected on the one hand to the central site (2) by a first transmission line (3), and on the other hand to the subscriber devices (12) by a second transmission line (13), which method is characterised by the following steps:
defining the tests to be performed on the first line (3) and the tests to be performed on the second line (13),
distributing said hardware and software resources between said central site (2) and said intermediate connection site (4) depending on the tests capable of being performed respectively on the first transmission line (3) and on the second transmission line (13).

2. Method according to claim 1, characterised in that said first and second transmission lines (3) and (13) comprise optical fibres and/or wire cables.

3. Method according to claim 2, characterised in that it comprises the following steps:
connecting the central site (2) and the intermediate site (4) by a first calibrated copper pair (3),
determining the total attenuation from end-to-end between the central site (2) and the subscriber devices (12),
deducing, from said total attenuation, the attenuation on said second transmission line (13),
determining, from the attenuation on said second line (13), the maximum bit rate capable of transiting via this second transmission line (13).

4. Method according to claim 2, characterised in that it consists of:
performing a first group of measurements by means of at least one remote control head (50) provided in the intermediate site (4),
transmitting the results of said measurements to a central control head (30) provided in the central site (2),
taking measurements on the wire connections on the second transmission line (13) by means of an access matrix (28) provided in said intermediate site (4).

5. Method according to claim 4, characterised in that said central control head (30) performs the following functions:
communication with a test manager (24), which performs the function of checking measurements and presenting the results to the users,
management of the interface with the remote control head (50),
processing of the uncorrected results of the measurements taken by the remote control heads (50),
processing of the reflectometric measurements taken by the remote control head (50) so as to obtain the attenuation, the length and possibly the topology of the line (13),
detection of ATU-R modems (29),
prediction of bit rate from attenuations measured on the cables of the second link (13) and from the broadband noise measured at the level of the remote control head (50),
verification of the functioning of the remote modems (ATU-R) (29) by xDSL synchronisation and activation of the upper layers such as ATM, PPP and IPVideo layers,
detection of line branching from frequency domain reflectometry (FDR) processing operations and from remote capacitance measurements,
narrow band verifications of possible resistive and/or capacitive defects in alternating and direct current,
detection of inductive loads,
presentation and remote processing of the measurement results.

6. Method according to claim 4, characterised in that the remote control head (50) provided in the intermediate site (4) performs the following functions:
communication with the central control head (30),
emulation of ATU-R modems (29) in order to test the ports of the DSLAM multiplexer (10) and the availability of multimedia services (voice, data, video),
testing and measurement of broadband and narrow band noise,
detection of ATU-R modems (29),
measurement of capacitance and resistance,
testing of AC and DC voltages,
verification of the telephone service provided via the line (13),
verification of line identifiers,
detection of inductive loads or branch lines.

7. Architecture for distribution of hardware and software resources for testing links between a plurality of subscriber devices (12) and a telecommunications operator, comprising:
a central control site (2) in which a central control head (30) is provided,
at least one intermediate connection site (4) connected on the one hand to the central site (2) by a first transmission line (3), and on the other hand to the subscriber devices (12) by a second transmission line (13),
which architecture is characterised in that said hardware and software resources are distributed between said central site (2) and said intermediate site (4) depending on the type of test likely to be performed respectively on the first transmission line (3) and on the second transmission line (13).

8. Architecture according to claim 7, characterised in that said first and second transmission lines (3) and (13) comprise optical fibres and/or wire cables.

9. Architecture according to claim 8, characterised in that said intermediate connection site (4) comprises a remote terminal (5) including a DSLAM multiplexer (10), a digital carrier (26) and an access matrix (28), and in that said first line (3) also comprises a first calibrated copper pair (3) intended to enable the central control head (30) to measure the total attenuation from end-to-end between the operator and the subscriber devices (12) and to deduce, from said attenuation, the total attenuation on said second transmission line (13) so as to determine the maximum bit rate capable of transiting via this second transmission line (13).

10. Architecture according to claim 9, characterised in that the attenuation on said second transmission line (13) is calculated by subtracting the attenuation on the calibrated copper pair (3) from the total attenuation measured, and the maximum bit rate capable of transiting via this second transmission line (13) is then calculated from the attenuation on said second transmission line (13).

11. Architecture according to claim 8, characterised in that the intermediate connection site (4) comprises a first remote terminal (5) including a DSLAM (10), a digital loop (26), a remote control head (50), and an access matrix (28), said first remote terminal (5) being connected directly to a first group of subscriber devices (12), said remote control head (50) being intended to perform a first group of test functions, and said access matrix (28) being intended to perform wire connection tests on the second transmission line (13).

12. Architecture according to claim 11, characterised in that the intermediate connection site (4) also comprises at least one second remote terminal (6), including a digital carrier (26) connected to a second reduced group of subscriber devices (12) via an external box (14), including a remote DSLAM (10), a remote control head (50) intended to perform a second group of line test functions, and an access matrix (28) for performing wire connection tests on the second transmission line (13).

13. Architecture according to claim 12, characterised in that the central site (2) comprises resources for performing the following functions:
communication with a test manager (24), which performs the function of checking measurements and presenting the results to the users,
management of the interface with the remote control head (50),
processing of the uncorrected results of the measurements taken by the remote control heads (50),
processing of the reflectometric measurements taken by the remote control head (50) so as to obtain the attenuation, the length and possibly the topology of the line (13),
detection of ATU-R modems (29),
prediction of bit rate from attenuations measured on the cables of the second link (13) and from the broadband noise measured at the level of the remote control head (50),
verification of the functioning of the remote modems (ATU-R) (29) by xDSL synchronisation and activation of the upper layers such as ATM, PPP and IPVideo layers,
detection of line branching from frequency domain reflectometry (FDR) processing operations and from remote capacitance measurements,
narrow band verifications of possible resistive and/or capacitive defects and measurement of alternating and direct voltages or currents,
detection of inductive loads (Load Coil detection),
presentation and remote processing of the measurement results.

14. Architecture according to claim 12, characterised in that the first remote terminal (5) comprises resources for performing the following functions:
communication with the central control head (30),
emulation of ATU-R modems (29) in order to test the ports of the DSLAM multiplexer (10) and the availability of multimedia services (voice, data, video),
testing and measurement of broadband and narrow band noise,
detection of ATU-R modems (29),
measurement of capacitance and resistance,
testing of AC and DC voltages,
verification of the telephone service (13),
verification of line identifiers (line ID),
detection of inductive loads or branch lines.

15. Architecture according to claim 12, characterised in that the remote control head (50), provided in the external box (4), comprises resources for performing the following functions:
communication with the central control head (30),
emulation of ATU-R modems (29) in order to test the ports of the DSLAM multiplexer (10) and the availability of multimedia services (voice, data, video),
testing and measurement of broadband and narrow band noise,
detection of ATU-R modems (29),
measurement of capacitance and resistance,
testing of AC and DC voltages,
verification of the telephone service (13),
detection of inductive loads.

16. Architecture according to claim 7, characterised in that the central site (2) comprises a first module for DSLAM processing (digital signal processing) (60) intended for the processing of a first group of functions, and the intermediate connection site (4) comprises a first remote terminal (5) including a second module for AFE (Analog Front End) DSLAM multiplexing (62) intended for the processing of a second group of functions, a digital carrier (26), and a remote control head (50) intended to perform a portion of the line tests, said first terminal (5) being directly connected to a first group of subscriber devices (12).

17. Architecture according to claim 12, characterised in that the intermediate connection site (4) also comprises at least one second remote terminal (6) connected to a second reduced group of subscriber devices (12) via an external box (14) including a digital carrier (26), a remote control head (50) intended to perform a portion of the line tests, and a third module for AFE DSLAM multiplexing (64) intended for the processing of a third group of functions.

18. Architecture according to claim 17, characterised in that the central site (2) comprises resources for performing the following functions:
communication with the test manager (24), which performs the function of checking the measurements and presenting the results to the users,
management of the interface with the remote control head (50),
processing of the uncorrected results of the measurements taken by the remote control heads (50);
processing of the reflectometric measurements taken by the remote control heads (50) in order to obtain the attenuation, the length and possibly the topology of the lines (13),
detection of ATU-R modems (29),
prediction of bit rate attenuations measured on the cables of the second link (13) and from the broadband noise measured at the level of the remote control heads (50),
verification of the proper functioning of the remote modem (ATU-R) (29) by xDSL synchronisation and activation of the upper layers such as the ATM, PPP and IPVideo layers,
detection of line branching from frequency domain reflectometry (FDR) processing operations and from remote capacitance measurements,
narrow band verifications of possible resistive and/or capacitive defects and measurement of alternating and direct voltages or currents,
detection of inductive loads,
presentation and remote processing of the measurement results.

19. Architecture according to claim 17, characterised in that said first remote terminal (5) and said external box (14) also comprise an access matrix (28) for enabling the central control head (30) to perform the following functions:
measurement of capacitance and resistance,
testing of AC and DC voltages,
verification of the telephone service (13),
verification of line identifiers,
detection of inductive loads.
